(19) United States
(12) Patent Application Publication
(10) Pub. No.: US 2024/0051860 A1
(43) Pub. Date: Feb. 15, 2024

(54) INSTALLATION FOR THE TREATMENT OF AN AQUEOUS STREAM OF PRODUCED WATER FROM AN OIL OR GAS FIELD

(71) Applicant: TOTALENERGIES ONETECH, Courbevoie (FR)

(72) Inventors: Frank Despinois, Pau cedex (FR); Lionel Mondelin, Jonage (FR); Frédéric Montazeau, Jonage (FR)

(73) Assignee: TOTALENERGIES ONETECH, Courbevoie (FR)

(21) Appl. No.: 18/268,063

(22) PCT Filed: Dec. 18, 2020
(86) PCT No.: PCT/IB2020/001107

§ 371 Date: Jun. 16, 2023

(51) Int. Cl. C02F 9/00; E21B 43/40; B01D 15/08

(52) U.S. Cl. CPC C02F 9/00; E21B 43/40; B01D 15/08; C02F 2103/10

(57) ABSTRACT

The invention relates to a modular installation for the treatment of an aqueous stream of produced water from an oil or gas field, said aqueous stream comprising water, suspended solids, residual hydrocarbons, at least one metal to be recovered and a first metal different from the metal to be recovered, the installation comprising: one or more movable metal treatment tanks (1) configured to precipitate the first metal in the aqueous stream; a filtration container (4) comprising a filtration unit (4c) configured to remove at least part of the suspended solids; and a separation container (6) comprising power and fluidic connectors, configured to receive and be connected to a separation unit (6c), the separation unit (6c) being configured to separate the metal to be recovered from the aqueous stream; the one or more movable metal treatment tanks (1), the filtration container (4) and the separation container (6) being fluidically connected, and the filtration container (4) being arranged downstream of the one or more movable metal treatment tanks (1) and upstream of the separation container (6). The invention further relates to a method for the treatment of an aqueous stream of produced water from an oil or gas field, implemented in the abovementioned installation.

### TECHNICAL FIELD

The present invention relates to a modular installation for the treatment of an aqueous stream of produced water from an oil or gas field, said aqueous stream comprising water, suspended solids, residual hydrocarbons, at least one metal to be recovered and a first metal different from the metal to be recovered. The present invention further relates to a method for the treatment of such aqueous stream implemented in said modular installation.

### TECHNICAL BACKGROUND

Produced water (in other words water recovered from a production well) and wastewater are produced in large volumes annually throughout the hydrocarbon and power production industries and are a considerable logistical and environmental liability for the companies producing them. Produced water contains substantive concentrations of hydrocarbon compounds and minerals.

The recovery of minerals, such as lithium, calcium or sodium, from water is a well-developed field which comprises the recovery of metals by implementing techniques such as ion exchange adsorption, solvent extraction, and co-precipitation. Such minerals may then be used in different applications. For example, lithium recovered from produced water may be used in fields such as ceramics, greases, aerospace, polymers, metal additives and particularly in the manufacture of lithium-ion batteries.

Given the importance of such minerals, it becomes necessary to test different technologies in order to adapt and enhance the mineral recovery based on the metal to be recovered and the treatment(s) to be implemented in each case.

In addition, metal recovery from water is often carried out in specific facilities, which thus involves transportation of the water to the facility, large capital investments related to the construction, maintenance of the facility and high operation costs.

Document WO 2019/000095 A1 relates to a method for recovering lithium from energy process water including the steps of removing alkaline earth metals from the water; passing the treated water through a reactor column containing a titanium oxide molecular sieve that adsorbs lithium ions; eluting the lithium ions from the molecular sieve using a strong acid solution; and collecting the resulting lithium-rich eluate fluid from the reactor column.

Document US 2020/0010927 A1 relates to a lithium adsorption-desorption apparatus including a plurality of reaction tanks arranged in a row, a guide rail disposed at an upper portion of the reaction tank, a movable driving unit coupled to a moving means that moves along the guide rail, and a reaction housing which is mounted to the driving unit and can be vertically moved or rotated in a state in which the lithium adsorbent is fixed thereto, and after immersing in the reaction tank, accelerates adsorption or desorption of lithium, and after being lifted, discharges residual solution from the lithium adsorbent by rotation movement.

Document EP 3382043 A1 relates to an onshore lithium-recovering device for a lithium ion adsorption and desorption process including a supply unit for supplying lithium-containing water in which lithium is dissolved, a composite unit, a washing unit, a desorbing liquid unit, an extract liquid unit, a pressure adjusting unit, a discharge unit, and a control unit.

Document WO 2019/084311 A1 relates to a modular extraction apparatus for the separation, purification and/or concentration of various elements from brine solutions. The modular extraction apparatus comprises a first tank, a second tank, and a third tank; an interconnection system for selectively directing a brine input stream to at least one of the first tank, the second tank, and the third tank; an amount of sorbent material contained within at least one of the first tank, the second tank, and the third tank, in which the sorbent material extracts at least one constituent from the brine input stream; and at least one of a purification membrane and a concentration membrane, for processing the extracted at least one constituent into at least one output stream.

There is thus a need for a modular installation for the treatment of an aqueous stream of produced water that makes it possible not only to recover at least one metal from the aqueous stream but also to adapt and enhance the recovery based on the metal to be recovered and the treatment(s) to be implemented. In addition, there is a need for a modular installation for the treatment of an aqueous stream of produced water which allows to study the effect of the concentration of the metal on the performance of the recovery.

### SUMMARY OF THE INVENTION

It is a first object of the invention to provide a modular installation for the treatment of an aqueous stream of produced water from an oil or gas field, said aqueous stream comprising water, suspended solids, residual hydrocarbons, at least one metal to be recovered and a first metal different from the metal to be recovered, the installation comprising:
one or more movable metal treatment tanks configured to precipitate the first metal in the aqueous stream;
a filtration container comprising a filtration unit configured to remove at least part of the suspended solids; and
a separation container comprising power and fluidic connectors, configured to receive and be connected to a separation unit, the separation unit being configured to separate the metal to be recovered from the aqueous stream;
the one or more movable metal treatment tanks, the filtration container and the separation container being fluidically connected, and the filtration container being arranged downstream of the one or more movable metal treatment tanks and upstream of the separation container.

According to some embodiments, the metal to be recovered is chosen from lithium, calcium, sodium, silicon, cobalt, manganese, cadmium, zirconium, zinc, nickel, copper, tungsten, yttrium, tin, lanthanum, silver, palladium and combinations thereof, and preferably wherein the metal to be recovered is lithium.

According to some embodiments, the one or more movable metal treatment tanks are chemical precipitation units and/or an oxidation units.

According to some embodiments, a source of base, preferably of sodium hydroxide solution, is fluidically connected to an inlet of the chemical precipitation units.

According to some embodiments, the oxidation units are provided with oxygen-containing gas bubbling devices.

According to some embodiments, the first metal is chosen from magnesium, iron and combinations thereof.

According to some embodiments, the modular installation comprises two movable metal treatment tanks, the second movable metal treatment tank being fluidically connected in parallel with the first movable metal treatment tank.

According to some embodiments, the one or more movable metal treatment tanks are mounted on wheels.

According to some embodiments, the modular installation further comprises a flotation container comprising a dissolved air flotation device configured to remove at least part of the suspended solids and residual hydrocarbons, the flotation container being fluidically connected to the one or more movable metal treatment tanks and the filtration container, the flotation container being arranged downstream of the movable metal treatment tanks and upstream of the filtration container.

According to some embodiments, the modular installation further comprises a movable reject tank fluidically connected to an outlet of the filtration container and/or to an outlet of the separation container, and/or to an outlet of the floatation container, when present.

According to some embodiments, the movable reject tank is mounted on wheels.

According to some embodiments, the filtration unit comprises a membrane configured to separate suspended solids having a volume-average median diameter Dv50 equal to or higher than 50 μm.

According to some embodiments, the modular installation comprises the separation unit connected to the power and fluidic connectors of the separation container.

According to some embodiments, the separation unit is a chromatographic separation unit, preferably comprising at least one chromatography column, preferably two, more preferably three and even more preferably four chromatography columns.

According to some embodiments, the modular installation further comprises at least one movable storage tank provided with a pH adjustment system.

According to some embodiments, the movable storage tank is fluidically connected to the filtration container and the separation container, and is arranged downstream of the filtration container and upstream of the separation container.

According to some embodiments, the movable storage tank comprises a recirculation loop configured to recirculate part of the aqueous stream to the movable storage tank.

According to some embodiments, the movable storage tank is mounted on wheels.

The invention further relates to a method for the treatment of an aqueous stream of produced water from an oil or gas field, implemented in the installation described above, the method comprising:
placing a first separation unit in the separation container and connecting the separation unit to the power and fluidic connectors in the separation container;
providing an aqueous stream comprising water, suspended solids, residual hydrocarbons, at least one metal to be recovered and a first metal different from the metal to be recovered;
passing the aqueous stream through the one or more movable metal treatment tanks so as to precipitate the first metal in the aqueous stream;
passing the aqueous stream through the filtration unit so as to remove at least part of the suspended solids from the aqueous stream;
passing the aqueous stream through the first separation unit so as to obtain an aqueous stream enriched in the metal to be recovered and an aqueous stream depleted in the metal to be recovered.

According to some embodiments, the metal to be recovered has a concentration equal to or higher than 3 g/L in the aqueous stream enriched in the metal to be recovered.

According to some embodiments, the metal to be recovered is chosen from lithium, calcium, sodium, silicon, cobalt, manganese, cadmium, zirconium, zinc, nickel, copper, tungsten, yttrium, tin, lanthanum, silver, palladium and combinations thereof, and preferably wherein the metal to be recovered is lithium.

According to some embodiments, the first metal is chosen from magnesium, iron and combinations thereof.

According to some embodiments, the aqueous stream depleted in the metal to be recovered is collected in the movable reject tank, and is preferably injected in one or more injection wells.

According to some embodiments, wherein at least part of the suspended solids removed in the step of passing the aqueous stream through the filtration unit is collected in the movable reject tank.

According to some embodiments, the first metal precipitates in the aqueous stream by the addition of a base, preferably of sodium hydroxide solution, in the aqueous stream and/or by bubbling an oxygen-containing gas in the aqueous stream.

According to some embodiments, at least part of the suspended solids and residual hydrocarbons are removed from the aqueous stream in the dissolved air flotation device prior to the step of passing the aqueous stream through the filtration unit.

According to some embodiments, at least part of the suspended solids and residual hydrocarbons is collected in the movable reject tank.

According to some embodiments, the suspended solids removed from the aqueous stream during the step of passing the aqueous stream through the filtration unit have a volume-average median diameter Dv50 equal to or higher than 50 μm.

According to some embodiments, the pH of the aqueous stream is adjusted in the movable storage tank prior to being fed to the first separation unit.

According to some embodiments, the method further comprises a step of disconnecting the first separation unit from the power and fluidic connectors of the separation container and then placing a second separation unit different from the first separation unit in the separation container and connecting the second separation unit to the power and fluidic connectors in the separation container, and repeating the steps of:
providing an aqueous stream comprising water, suspended solids, residual hydrocarbons, at least one metal to be recovered and a first metal different from the metal to be recovered;
passing the aqueous stream through the one or more movable metal treatment tanks so as to precipitate the first metal in the aqueous stream;
passing the aqueous stream through the filtration unit so as to remove at least part of the suspended solids from the aqueous stream;
passing the aqueous stream through the second separation unit so as to obtain an aqueous stream enriched in the metal to be recovered and an aqueous stream depleted in the metal to be recovered.

The present invention makes it possible to address the need expressed above. In particular the invention provides a modular installation for the treatment of an aqueous stream of produced water that makes it possible not only to recover at least one metal from the aqueous stream but also to adapt and enhance the recovery based on the metal to be recovered and the treatment(s) to be implemented. In addition, the invention provides a modular installation for the treatment of an aqueous stream of produced water which allows to study the effect of the concentration of the metal on the performance of the recovery.

More particularly, the modular installation of the present invention comprises at least one movable metal treatment tank, a filtration container comprising a filtration unit and a separation container configured to receive and be connected to a separation unit, the separation unit being configured to separate the metal to be recovered from the aqueous stream. Thus, the modular installation of the present invention makes it possible to connect different separation units to the separation container in order to recover a variety of metals from the aqueous stream of produced water. In other words, depending on the metal to be recovered and the treatment to be implemented, different separation units can be connected to the separation container. For example, a first separation unit may be connected to the separation container in order to recover lithium from the aqueous stream of produced water, and then, the first separation unit may be disconnected from the separation container and a second separation unit may be connected to such container, in order to recover another metal, for example calcium or sodium.

In addition, due to the modular installation of the present invention, which comprises mobile tanks and containers, such treatment can be carried out on site in an oil, natural gas or condensate field. This provides an advantage as the installation may be connected to one or more injection and/or production well pads directly providing such installation with the stream of produced water to be treated. As the concentration of the metal to be recovered in the stream of produced water varies over time, the modular installation of the present invention makes it possible to study the effect of the concentration of the metal on the performance of the recovery.

### BRIEF DESCRIPTION OF THE DRAWINGS

FIG. 1 schematically illustrates a modular installation according to an embodiment of the invention.

FIG. 2 schematically illustrates a modular installation according to an embodiment of the invention.

### DETAILED DESCRIPTION

The invention will now be described in more detail without limitation in the following description.

### Aqueous Stream of Produced Water

The present invention relates to the treatment of an aqueous stream of produced water from a subterranean formation in an oil or gas field. By “produced water” is meant the water recovered from one or more production wells during the recovery of hydrocarbons, and separated from the recovered hydrocarbons.

The aqueous stream of produced water thus contains water and residual hydrocarbons. In addition, the aqueous stream of produced water also comprises suspended solids, at least one metal to be recovered and a first metal different from the metal to be recovered. The present invention thus allows to recover a metal (to be recovered) from the aqueous stream.

The metal to be recovered may be chosen from lithium, calcium, sodium, silicon, cobalt, manganese, cadmium, zirconium, zinc, nickel, copper, tungsten, yttrium, tin, lanthanum, silver, palladium and combinations thereof. According to preferred embodiments, the metal to be recovered is lithium.

The metal to be recovered may be present in the aqueous stream of produced water at a content from 0 to 550 mg/L, and preferably from 30 to 150 mg/L. This content may be measured by inductively coupled plasma (ICP) methods.

The first metal may be chosen from magnesium, iron, manganese, sodium and combinations thereof. Preferably, the first metal may be chosen from magnesium, iron and their combinations.

The first metal may be present in the aqueous stream of produced water at a content from 0 to 2000 mg/L, preferably from 1000 to 1500 mg/L, and more preferably from 1400 to 1500 mg/I. This content may be measured by inductively coupled plasma (ICP) methods.

The aqueous stream may have a salinity from 0 to 200 g/L, preferably from 150 to 200 g/L, and more preferably from 185 to 195 g/L. Salinity is defined herein as the total concentration of dissolved inorganic salts in water, including e.g. NaCl, CaCl₂, MgCl₂ and any other inorganic salts.

The aqueous stream may have a content in suspended solids lower than 5 g/L, and preferably from 50 to 70 mg/L. This content may be measured by filtration or turbidity methods.

The aqueous stream may have a content in residual hydrocarbons lower than 100 ppm, and preferably from 10 to 20 mg/L. This content is measured by Gas Chromatography or UV Fluorescence or Infrared methods.

By “residual hydrocarbons” is meant hydrocarbons from the subterranean formation remaining in the produced water after the initial separation of the recovered hydrocarbons from the produced water.

### Modular Installation for the Treatment of an Aqueous Stream of Produced Water

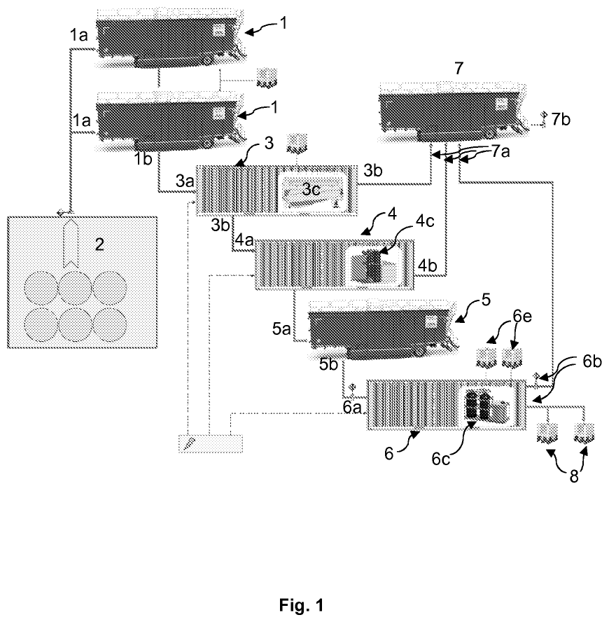

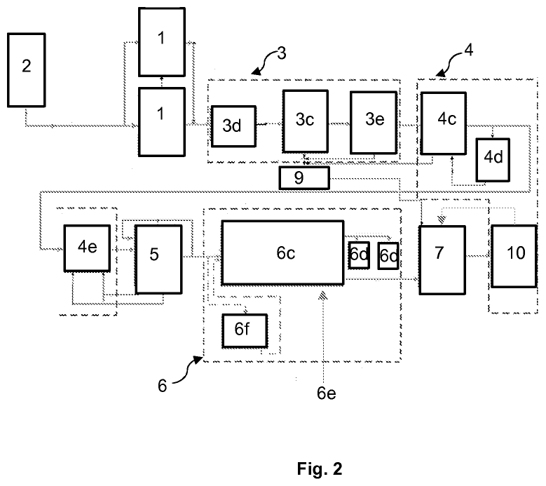

The present invention relates to a modular installation for the treatment of the aqueous stream of produced water described above. By “modular installation” is meant an installation which comprises parts that can be connected or combined in different ways. The modular installation according to the present invention will be described by making reference to FIGS. 1 and 2.

The modular installation comprises a number of movable tanks and containers.

By “movable tank” is meant a tank that can be moved without being dismantled, in other words a tank that is not fixed in one place. Each movable tank may be mounted on wheels. Each movable tank may be for example in the form of a truck trailer. The dimensions of each movable tank may range from 1 to 20 m long and 1 to 5 m width, preferably from 5 to 15 m long, and 2 to 4 m width. More preferably such tank may have a dimension of 13 m long and 2.5 m width.

Each of the containers of the present invention (flotation container 3, filtration container 4, separation container 6) may have a volume independently from one another from 10 m³ to 50 m³.

By “container” is meant a box, preferably made of metal, placed on the ground, which can be transported by a vehicle. Preferably the containers are not mounted on wheels. The dimensions of each container may range from 12191 mm (length)×2438 mm (width)×2592 mm (height) to 6060 mm (length)×2438 mm (width)×2592 mm (height).

The movable tanks of the present invention (movable metal treatment tank(s) 1, movable storage tank 5, movable reject tank 7) may have a volume independently from one another from 10 to 50 m³, and preferably from 30 to 40 m³.

Preferably, the containers and movable tanks of the installation are not enclosed in a building.

The modular installation comprises at least one movable metal treatment tank 1 which is configured to precipitate the first metal from the aqueous stream.

According to some embodiments, the movable metal treatment tank 1 may be chosen from a chemical precipitation unit or an oxidation unit.

According to preferred embodiments, the movable metal treatment tank 1 may be a chemical precipitation unit and an oxidation unit. In this case, two different metal treatments can be carried out in the movable metal treatment tank 1.

By “chemical precipitation unit” is meant a unit wherein a separable solid substance from a solution is formed, by converting the substance into an insoluble form. In the context of the present invention, the chemical precipitation leads to the precipitation of the first metal. For example, such metal may be chosen from magnesium.

The chemical precipitation may be carried out by adding a basic solution such as sodium hydroxide to the aqueous stream.

In this case, a source of base (basic solution) is fluidically connected to an inlet of the chemical precipitation units

By “oxidation unit” is meant a unit wherein the oxidation of a substance makes it possible to separate such substance from a solution. In the context of the present invention, the oxidation of the first metal makes it possible to precipitate such first metal and separate it from the aqueous stream. For example, such metal may be chosen from iron.

The oxidation may be carried out by bubbling an oxygen-containing gas in the aqueous stream.

In this case, the oxidation unit may be provided with one or more oxygen-containing gas bubbling devices. The oxygen-containing gas may be oxygen or, preferably, air.

The movable metal treatment tank 1 may comprise at least one inlet 1a (for the introduction of the aqueous stream into the movable metal treatment tank 1) and at least one outlet 1b (for the discharge of the aqueous stream from the movable metal treatment tank 1).

The at least one inlet 1a of the movable metal treatment tank 1 may be fluidically connected (via a pipe or a tube for example) to one or more tanks 2 comprising the aqueous stream to be treated (as illustrated in FIG. 1). These tanks 2 may be considered as part of the installation or may be considered as not belonging to the installation, the installation being fluidically connected to the tanks 2. The tanks 2 may be different from movable tanks. They may be permanently fixed to the ground. The volume of the tanks 2 may be from 10 to 50 m³, and preferably from 30 to 40 m³. If more than one tanks 2 are present, a manifold may be used so that each tank 2 may be fluidically connected, in turn, to the inlet 1a of the movable metal treatment tank 1.

Alternatively, the at least one inlet 1a of the movable metal treatment tank 1 may be directly fluidically connected (without the intermediate of a tank or a container) to one or more production wells via a pipe or a tube for example (not illustrated in the figures).

The at least one outlet 1b may be fluidically connected to another unit, tank, or container of the modular installation of the invention (as will be described below).

According to some embodiments, only one movable metal treatment tank 1 is present in the modular installation of the present invention.

According to preferred embodiments, the modular installation comprises more than one movable metal treatment tanks 1, preferably two movable metal treatment tanks 1 (thus a first and a second movable metal treatment tank 1). The second movable metal treatment tank 1 is preferably the same as the (first) movable metal treatment tank 1 described above. Alternatively, the second movable metal treatment tank 1 may be different from the (first) movable metal treatment tank 1.

In case the modular installation comprises two movable metal treatment tanks 1, the second movable metal treatment tank 1 is fluidically connected to the first movable metal treatment tank 1. This fluidic connection may be in series (in other words the second movable metal treatment tank 1 is fluidically connected to the first movable metal treatment tank 1 (downstream thereof) and the aqueous stream is first treated in the first movable metal treatment tank 1 and then in the second movable metal treatment tank 1) or more preferably this fluidic connection may be in parallel (in other words the aqueous stream is treated at the same time in either the first or second movable metal treatment tank 1) as illustrated in FIG. 1.

In this latter case, the aqueous stream may be divided into streams, each stream being treated in one movable metal treatment tank 1, the streams being mixed again downstream. The movable metal treatment tanks 1 then operate simultaneously. Alternatively, all of the aqueous stream may pass through only one movable treatment tank, while the other movable treatment tank 1 is stopped e.g. for servicing (notably rinsing as will be explained below). Periodically, the aqueous stream may be switched to the other movable treatment tank 1.

The above also applies in a similar manner if more than two movable treatment tanks 1 are provided.

The modular installation according to the invention may comprise a flotation container 3. The floatation container 3 comprises a dissolved air flotation device 3c configured to remove at least part of the suspended solids and residual hydrocarbons from the aqueous stream. Thus, the flotation container 3 may be fluidically connected to (downstream of) the at one or more movable metal treatment tanks 1.

According to some embodiments (as illustrated in FIG. 2), the flotation container 3 may further comprise a coagulation and/or flocculation unit 3d connected to (upstream of) the dissolved air flotation device 3c. The unit may thus comprise at least one, preferably two coagulant pumps (one of which is a spare pump) and at least one, preferably two flocculant pumps (one of which is a spare pump). In this case, a coagulant may be added in the coagulation and/or flocculation unit 3d in order to destabilize particles through chemical reaction between the coagulant and the particles, while a flocculant can be added in said unit to transport the destabilized particles that will form flocs or flakes.

The coagulant used may be an emulsion comprising one or more anionic polyacrylamide such as FLOPAM™ EM 430 commercialized by SNF Floerger. The flocculant used may be an aqueous solution of aluminum chloride such as FLOQUAT™ PAC 18 commercialized by SNF Floerger.

Furthermore, the flotation container 3 may comprise a storage and surface solid hydrocarbon deoiler 3e connected to (downstream of) the dissolved air flotation device 3c. In this case, water is mixed with air in a specific pump, and then the coagulant and the flocculant are added to the mixture. In this device, a part of suspended solids may be floated by air dissolved and trapped by micro bubbles. All floated elements may then be removed by scrappers. Heavy sludge (material) may drop at the bottom of the unit. Such sludge may be regularly and automatically removed by an on/off valve. The sludge pump handles even floated and fallen sludge. The flotation container may be built to operate with explosive gas. The roof may be closed and vented with fresh air by e.g. two air fans. The equipment may be made of spark-proof material.

The flotation container 3 may comprise at least one inlet 3a for the introduction of the aqueous stream in the floatation container 3 and at least one outlet 3b for the discharge of the aqueous stream from the floatation container 3. For example, the flotation container 3 may be fluidically connected to the one or more movable metal treatment tanks 1 via a tube or a pipe connecting the outlet(s) 1b of the movable metal treatment tank(s) 1 to the inlet 3a of the flotation container 3. In addition, the flotation container 3 may comprise one and preferably two outlets 3b, each one of the outlets 3b being fluidically connected to different units of the modular installation as will be described below.

The modular installation further comprises a filtration container 4 which comprises a filtration unit 4c configured to remove at least part of the suspended solids. Preferably, suspended solids having a volume-average median diameter Dv50 equal to or higher than 50 μm can be separated from the aqueous stream in this filtration unit 4c.

Therefore, according to some embodiments, the filtration unit 4c may comprise a membrane configured to separate suspended solids having a volume-average median diameter Dv50 equal to or higher than 50 μm. Alternatively, a sand filter configuration can be used.

According to some embodiments (as illustrated in FIG. 2), the filtration container 4 may further comprise a storage and pumping unit 4d connected to (downstream of) the filtration unit 4c.

In addition, as illustrated in FIG. 2, the filtration container 4 may further comprise a pH adjustment device 4e connected to (downstream of) the filtration unit 4c and also downstream of the storage and pumping unit 4d (if such unit is present. The pH adjustment device 4e makes it possible to adjust the pH of the aqueous stream by the addition of a basic solution (such as sodium hydroxide) and/or an acidic solution (such as hydrochloride) in the pH adjustment device 4e.

The filtration container 4 may comprise at least one inlet 4a for the introduction of the aqueous stream in the filtration container 4 (and thus in the filtration unit 4c) and at least one outlet 4b for the discharge of the aqueous stream from the filtration container 4.

The filtration container 4 is fluidically connected (directly or indirectly) to the metal treatment tank(s) 1 (downstream thereof, for example via a pipe or a tube).

In case the modular installation is devoid of a flotation container 3, the filtration container 4 is directly fluidically connected to the movable metal treatment tank(s) 1. Thus, the outlet 1b of the movable metal treatment tank(s) 1 is fluidically connected to the inlet 4a of the filtration container 4. However, in case the modular installation comprises a flotation container 3, as illustrated in FIG. 1, the inlet 4a of the filtration container 4 is fluidically connected to the outlet 3b of the flotation container 3.

According to preferred embodiments, the filtration container 4 comprises at least two outlets 4b in order to fluidically connect each one of the outlets 4b to different units of the modular installation.

According to preferred embodiments, the modular installation according to the present invention may further comprise at least one movable storage tank 5. The movable storage tank 5 is provided with a system configured to adjust the pH of the aqueous stream by the addition of a basic solution (such as sodium hydroxide) and/or an acidic solution (such as hydrochloride) in the movable storage tank 5.

Thus, the movable storage tank 5 can be present in case the filtration container 4 is devoid of a pH adjustment device 4e. In other words, the pH of the aqueous stream can be adjusted in the filtration container 4 if this container is provided with a pH adjustment device 4e or in the movable storage tank 5 if the filtration container 4 is devoid of a pH adjustment device 4e.

The movable storage tank 5 may comprise at least one inlet 5a for the introduction of the aqueous stream in the movable storage tank 5 and at least one outlet 5b for the discharge of the aqueous stream from the movable storage tank 5. When present, the movable storage tank 5 may be fluidically connected to the filtration container 4 (downstream thereof) via a pipe or a tube.

According to preferred embodiments, the movable storage tank 5 comprises at least one pump.

Still according to preferred embodiments, the movable storage tank 5 comprises at least one valve. This valve may preferably be located at the outlet 5b of the movable storage tank 5 or downstream of the outlet 5b of the movable storage tank 5 for example on a pipe or tube connecting the outlet 5b of the movable storage tank 5 with the inlet of another unit, container or tank (as will be described below).

The presence of such valve and pump make it possible to control the flow rate of the aqueous stream entering the unit which is connected downstream of the movable storage tank 5 (the separation container 6 as will be explained below). More particularly, as the pump may be operated in a continuous manner, by controlling the valve thus controlling the amount of aqueous stream entering the unit connected downstream of the movable storage tank 5, the desired flow rate may be achieved. A recirculation loop might be present to recirculate part of the aqueous stream to the movable storage tank 5.

The modular installation according to the invention further comprises a separation container 6 which is configured to receive and be connected to a separation unit 6c. Therefore, the separation container 6 comprises power and fluidic connectors which make it possible to connect the separation unit 6c to the separation container 6. The fluidic connectors may notably be tubes or pipes that connect the separation unit 6c to the rest of the installation. In addition, the provision of power by the separation container 6 makes it possible to operate the separation unit 6c. The connection may be carried out by tie-in connection points, which may consist of a plurality of flanges e.g. according to the standard DIN 2501 PN10 dedicated for water supply, effluent inlet, adsorption outlet, air supply and elution outlet. A spare tie-in connection point may also be provided, leading to a total of six tie-in connection points.

When the separation unit 6c is in place in the separation container 6, it is fully enclosed in this container.

The separation unit 6c is configured to separate the metal to be recovered from the aqueous stream. The separation unit 6c may be a chromatographic separation unit, notably an ion exchange unit. Alternatively, the separation unit 6c may be a membrane separation unit or an electro dialysis unit.

In case the separation unit 6c is a chromatographic separation unit, such unit may comprise at least one chromatography column, preferably two, more preferably three and even more preferably four chromatography columns. For example, the chromatographic separation unit may comprise at least one absorption column, and at least one elution column, and preferably at least one rinsing column.

As illustrated in FIG. 2, the separation container 6 may further comprise one or more storage units 6d for collecting and storing the metal recovered in the separation unit 6c, for example in the form of an aqueous stream comprising such metal.

Alternatively, as illustrated in FIG. 1, notably in case the separation container 6 is devoid of storage unit(s) 6d, the collection and storage of the recovered metal can be carried out in distinct collection units 8 connected to the separation container 6.

Furthermore, the separation container 6 may comprise at least one inlet 6a for the introduction of the aqueous stream in the separation container 6 (and thus in the separation unit 6c which may be comprised and connected in the separation container 6) and at least one, and preferably at least two outlets 6b for the discharge of the aqueous stream from the separation container 6.

The separation container 6 is fluidically connected (directly or indirectly) to the filtration container 4 (downstream thereof, for example via a pipe or a tube). In case the modular installation is devoid of a movable storage tank 5, the separation container 6 is directly fluidically connected to the filtration container 4 (not illustrated in the figures). Thus, the outlet 4b of the filtration container 4 is fluidically connected to the inlet 6a of the filtration container 6. However, in case the modular installation comprises a movable storage tank 5, the inlet 6a of the separation container 6 is fluidically connected to the outlet 5b of the filtration container 5.

According to preferred embodiments, the separation container 6 comprises at least two outlets 6b in order to fluidically connect each one of the outlets to different units of the modular installation.

According to some embodiments, the separation container 6 may comprise a second inlet (different from the first inlet 6a for the introduction of the aqueous stream). Thus, a source of fluid 6e may be connected to this second inlet of the separation container 6 in order to provide a fluid in the separation container 6 and thus in the separation unit 6c. The source of fluid 6d may comprise for example a fluid necessary for the separation of the metal to be recovered such as an elution fluid, a washing fluid or a rinsing fluid. One or more sources of fluid 6e may be connected to the separation container 6.

In addition, the separation container 6 may also comprise a pH adjustment and aeration unit 6f. Such unit may be present for example in case the installation is devoid of a movable storage tank 5 or of a pH adjustment device 4e. In this case, the pH of the aqueous stream can be adjusted prior to the entry of the aqueous stream inside the separation unit 6c.

The modular installation may further comprise a movable reject tank 7. The movable reject tank 7 may comprise one or more inlets 7a for the introduction of a fluid and one or more outlets 7b for the discharge of a fluid.

The movable reject tank 7 may be fluidically connected to (via a pipe or a tube) the separation container 6, downstream thereof (for example the outlet 6b or one of the outlets 6b of the separation container 6 may be connected to the inlet 7a or one of the inlets 7a of the movable reject tank 7).

Alternatively or additionally, the movable reject tank 7 may be fluidically connected (via a pipe or a tube) to the filtration container 4, downstream thereof (for example the outlet 4b or one of the outlets 4b of the filtration container 4 may be connected to the inlet 7a or one of the inlets 7a of the movable reject tank 7).

Alternatively or additionally, the movable reject tank 7 may be fluidically connected (via a pipe or a tube) to the flotation container 3, downstream thereof (for example the outlet 3b or one of the outlets 3b of the flotation container 3 may be connected to the inlet 7a or one of the inlets 7a of the movable reject tank 7).

The movable reject tank 7 may be configured to adjust the pH of the fluid located in such tank. pH adjustment may be carried out by the addition of a basic solution (such as sodium hydroxide) and/or an acidic solution (such as hydrochloride) in the movable reject tank 7.

The movable reject tank 7 may also be configured to adjust the oxygen concentration of the fluid located in such tank. This may be carried out by adding an oxygen-containing gas in the movable reject tank 7.

According to some embodiments, the outlet 7b of the movable reject tank 7 may be connected to one or more injection wells (not illustrated in the figures).

According to preferred embodiments, the movable reject tank 7 may be mounted on wheels.

The modular installation of the present invention may also comprise one or more sensors present in one or more tanks or containers of the modular installation. Such sensors may be chosen from oxygen sensors, pH sensors, temperature sensors, pressure sensors, gas detectors, and online metals monitoring sensors.

According to some embodiments, the modular installation according to the invention may further comprise one or more by-pass valves. Such valves may be located between two different containers and/or tanks (or between a container and a tank) and make it possible to by-pass a specific tank or container and thus a specific treatment. For example, a by-pass valve placed between the movable metal treatment tank 1 and the flotation container 3, makes it possible for the aqueous stream to by-pass the flotation container 3 and directly enter the filtration container 4.

A by-pass line and valve to by-pass the filtration container 4 may also be provided in the installation.

### Method for the Treatment of an Aqueous Stream of Produced Water

The present invention also relates to a method for the treatment of the aqueous stream described above. This method is implemented in the modular installation also described above.

The method according to the invention comprises a (first) step of placing the separation unit 6c in the separation container 6 described above. The (first) separation unit 6c may be as described above. The separation unit 6c is configured for separating a specific metal from the aqueous stream (metal to be recovered). For example, this metal may be lithium.

The connection between the separation container 6 and the separation unit 6c can be made by the power and fluidic connectors of the separation container 6.

The method then comprises a step of providing an aqueous stream of produced water (as detailed above).

According to some embodiments, the aqueous stream may be provided directly from one or more production wells (for example via a pipe or a tube connecting the production well(s) with the modular installation of the present invention.

According to other embodiments, the aqueous stream may be provided from a tank 2 that contains production water recovered from one or more production wells.

The aqueous stream of produced water may be provided with a flow rate of 1 to 15 m³/h, and preferably from 3 to 10 m³/h. For example, this flow rate may be from 1 to 3 m³/h; or from 3 to 6 m³/h; or from 6 to 9 m³/h; or from 9 to 12 m³/h; or from 12 to 15 m³/h, owing to one more pumps.

The method of the present invention further comprises a step of passing the aqueous stream of produced water through the movable metal treatment tank(s) 1 described above. This allows to precipitate the first metal from the aqueous stream of produced water. For example, the aqueous stream entering the movable metal treatment tank 1 may undergo a chemical precipitation (for example by the addition of a sodium hydroxide solution to precipitate magnesium) and/or an oxidation (for example by bubbling an oxygen-containing gas in the aqueous stream to precipitate iron) as detailed above.

Thus, according to some embodiments the first metal is magnesium.

According to other embodiments the first metal is iron.

Still according to other embodiments, the first metal is a combination of magnesium and iron.

In case the modular installation according to the invention comprises two movable metal treatment tanks 1, the aqueous stream may first be treated in the first movable metal treatment tank 1 and then in the second movable metal treatment tank 1. Alternatively (notably when the movable metal treatment tanks 1 are connected in parallel), the aqueous stream is treated at the same time in either the first or second movable metal treatment tank 1; or the aqueous stream may be treated in only one of two movable treatment tanks 1, while the other one is stopped.

At the end of this step, the aqueous stream leaving the movable metal treatment tank(s) 1 may have a content in the first metal equal to or lower than 2000 mg/L, and preferably equal to or lower than 1800 mg/L This content may be measured by inductively coupled plasma (ICP) methods. This content may be from 5 to 10 mg/L; or from 10 to 100 mg/L; or from 100 to 250 mg/L; or from 250 to 500 mg/L; or from 500 to 1000 mg/L; or from 1000 to 1500 mg/L; or from 1500 to 2000 mg/L.

More particularly, when the first metal is magnesium the aqueous stream leaving the movable metal treatment tank(s) 1 may have a content in magnesium from 1400 to 1800 mg/L, while when the first metal is iron, the aqueous stream leaving the movable metal treatment tank(s) 1 may have a content in iron from 70 to 200 mg/L

The precipitates formed during this step (comprising the first metal) may exit the movable metal treatment tank(s) 1 in the aqueous stream in the form of (additional) suspended solids.

Alternatively, or additionally, the precipitates formed during this step may sediment at the bottom of the movable metal treatment tank(s) 1. In this case, the movable metal treatment tank(s) 1 may be treated (in other words rinsed) periodically in order to remove such precipitates.

After exiting the movable metal treatment tank(s) 1, the aqueous stream may enter the flotation container 3 and thus the dissolved air flotation device 3c. This makes it possible to remove at least part of the suspended solids and residual hydrocarbons.

In case the flotation container 3 comprises a coagulation and flocculation unit 3d, as described above, the aqueous stream may first enter this unit prior to entering the dissolved air flotation device 3c. This makes it possible to test the effect of the suspended solids and residual hydrocarbons on the ion exchange media performances.

The residual hydrocarbons and the suspended solids may form a sludge in the dissolved air flotation device 3c. Coagulation and flocculation may be handled online inside the flotation container 3. Injection and dosing may be fully automated. The flocculant may be previously diluted at the right concentration by a full automatic dosing system. The sludge may exit the dissolved air flotation device 3c (and thus the flotation container 3) from a second outlet 3b of the flotation container 3 and be collected in the reject tank 7 (as described above) for example via an intermediate sludge separation and pumping unit 9.

In addition, in case the flotation container 3 comprises a storage and surface solid hydrocarbon deoiler 3e, as described above, the aqueous stream exiting the dissolved air flotation device 3c may enter the storage and surface solid hydrocarbon deoiler 3e.

At the end of this step, the aqueous stream leaving the flotation container 3 (for example from a first outlet 3b of the flotation container 3) may have a content in residual hydrocarbons equal to or lower than 10 mg/L, and preferably equal to or lower than 5 mg/L measured by Gas Chromatography or UV Fluorescence or Infrared methods.

The method according to the present invention then comprises a step of passing the aqueous stream through the filtration container 4 and thus through the filtration unit 4c described above. This allows to remove at least part of the suspended solids from the aqueous stream, notably suspended solids having a volume-average median diameter Dv50 equal to or higher than 50 μm.

This separation may be carried out by using a membrane which allows filtration of the aqueous stream. Alternatively, geotubes can be used.

In case the filtration container 4 comprises a storage and pumping unit 4d, as described above, the aqueous stream exiting the filtration unit 4c may enter the storage and pumping unit 4d in order to reach a cut-off level of 50 μm. In addition, in case the filtration container 4 comprises a pH adjustment device 4e, as described above, the aqueous stream exiting the filtration unit 4c (and optionally the storage and pumping unit 4d) may enter the pH adjustment device 4e. This makes it possible to adjust the pH of the aqueous stream by the addition of a basic solution (such as sodium hydroxide) and/or an acidic solution (such as hydrochloride) in the aqueous stream. According to some embodiments, during this step, the pH of the aqueous solution may be adjusted at a value from 3 to 8, and preferably from 5 to 7.

At the end of this step, the aqueous stream leaving the filtration container 4 (for example from a first outlet 4b of the filtration container 4) may have a content in suspended solids equal to or lower than 10 mg/L, and preferably equal to or lower than 5 mg/L measured by filtration or turbidity methods.

During this step, the residual hydrocarbons may form a sludge in the filtration unit 4c. This sludge may exit the filtration unit 4c (and thus the filtration container 4) from a second outlet 4b of the filtration container 4 and be collected in the reject tank 7 (as described above) for example via an intermediate unit 9 along with the sludge deriving from the flotation container 3.

The aqueous stream leaving the filtration container 4 may then enter the movable storage tank 5 as described above. In this tank, the pH of the aqueous stream may be adjusted for example by adding an acidic solution (for example a hydrochloride solution) and/or a basic solution (for example a sodium hydroxide solution) in the movable storage tank 5. This step is carried out preferably when the filtration container 4 is devoid of pH adjustment device 4e, in other words, when a step of adjusting the pH of the aqueous stream is not carried out in the filtration container 4. Alternatively, as mentioned above, the pH adjustment can be carried out in the separation container 6 and more particularly in the pH adjustment and aeration unit 6f.

According to some embodiments, during this step, the pH of the aqueous solution may be adjusted at a value from 3 to 8, and preferably from 5 to 7.

The aqueous stream may also be stored in the movable tank 5 for a duration from 1 to 4 hours and preferably from 1 to 2 hours.

After exiting the movable storage tank 5, the aqueous stream enters the first separation unit 6c which is connected to the separation container 6.

As detailed above, due to the presence of the valve and pump in the movable storage tank 5 (and notably due to the presence of the recirculation loop) it is possible to alter and control the flow rate of the aqueous stream entering the separation container 6 and thus the separation unit 6c.

This flow rate may be for example from 0.1 to 5 m³/h and preferably from 1 to 5 m³/h.

In the separation unit 6c, the at least one metal to be recovered is separated from the aqueous stream. Such separation may be carried out by chromatographic purification, for example by passing the aqueous stream through one or more chromatographic columns that adsorb the metal to be recovered and separate it from the aqueous stream. The metal to be recovered may then be collected by elution of the chromatographic columns with an elution solution (such as water or a hydrochloride solution) provided in the separation unit 6c from the source of fluid 6e (as explained above). Alternatively, such separation may be carried out by hybrid membranes (in other words membranes that are a composite of inorganic and polymeric membranes such as a combination of molecular sieving materials in polymeric matrix structure).

At the end of this step, an aqueous stream enriched in the metal to be recovered is obtained on the one hand and an aqueous stream depleted in the metal to be recovered is obtained on the other hand.

The aqueous stream enriched in the metal to be recovered may have a concentration equal to or higher than 3 g/L in the aqueous stream enriched in the metal to be recovered. For example, the aqueous stream enriched in the metal to be recovered may have a concentration from 3 to 5 g/L; or from 5 to 10 g/L; or from 10 to 15 g/L; or from 15 to 20 g/L; or from 20 to 25 g/L; or from 25 to 30 g/L; 30 to 35 g/L; or from 35 to 40 g/L. This content may be measured by inductively coupled plasma (ICP) methods.

The aqueous stream enriched in the metal to be recovered may be collected either in a storage unit 6d present in the separation container 6 (as illustrated in FIG. 2) or in a distinct unit 8 connected to a first outlet 6b of the separation container 6 (as illustrated in FIG. 1). Such stream may then be sent to a lithium refinery.

The aqueous stream depleted in the metal to be recovered may exit the separation container 6 from a second outlet 6b of the separation container 6 and may be collected in the movable reject tank 7 along with the sludge deriving from the flotation container 3 and/or the filtration container 4.

According to some embodiments, the mixture of the aqueous stream depleted in the metal to be recovered and the sludges deriving from the flotation container 3 and/or the filtration container 4 may undergo a pH adjustment for example by adding an acidic solution (for example a hydrochloride solution) and/or a basic solution (for example a sodium hydroxide solution) in the movable reject tank 7. This pH adjustment can be carried out by a pH control loop 10 located in the filtration container 4.

Alternatively or additionally, the mixture of the aqueous stream depleted in the metal to be recovered and the sludges deriving from the flotation container 3 and/or the filtration container 4 may undergo an adjustment of the oxygen concentration for example by adding an oxygen-containing gas or a bisulfite solution in the movable reject tank 7.

Alternatively or additionally, water may be added to such mixture.

This mixture may then be reinjected in one or more injection wells.

The method according to the present invention may further comprise a step of disconnecting the first separation unit 6c from the power and fluidic connectors of the separation container 6 and then placing a second separation unit 6c in the separation container 6 and connecting the second separation unit 6c to the power and fluidic connectors in the separation container 6. The second separation unit 6c is preferably different from the first separation unit 6c.

According to some embodiments, the second separation unit 6c may be configured to separate the same metal to be recovered as the first separation unit 6c. For example, the first separation unit 6c may be a chromatographic separation unit configured to recover a metal to be recovered (such as lithium for example) and the second separation unit 6c may be a membrane separation unit or an electrodialysis unit and configured to recover the same metal to be recovered (such as lithium). This makes it possible to efficiently test different technologies for the separation of the same metal in order to improve the metal recovery.

According to other embodiments, the second separation unit 6c may be configured to separate a different metal from the one recovered with the first separation unit 6c. For example, the first separation unit 6c may be a chromatographic separation unit configured to recover a first metal to be recovered (such as lithium for example) and the second separation unit 6c may also be a chromatographic separation unit configured to recover a second metal to be recovered (such as calcium) notably by using a different absorbent material or different elution solutions. This allows to efficiently modify and adapt the modular installation for the recovery of different metals.

Thus, after disconnecting the first separation unit 6c and after connecting the second separation unit 6c to the separation container 6, the above-mentioned steps can be repeated in order to carry out another metal recovery.

What is claimed is:

1. A modular installation for the treatment of an aqueous stream of produced water from an oil or gas field, said aqueous stream comprising water, suspended solids, residual hydrocarbons, at least one metal to be recovered and a first metal different from the metal to be recovered, the installation comprising:
one or more movable metal treatment tanks configured to precipitate the first metal in the aqueous stream;
a filtration container comprising a filtration unit configured to remove at least part of the suspended solids; and
a separation container comprising power and fluidic connectors, configured to receive and be connected to a separation unit, the separation unit being configured to separate the metal to be recovered from the aqueous stream;
the one or more movable metal treatment tanks, the filtration container and the separation container being fluidically connected, and the filtration container being arranged downstream of the one or more movable metal treatment tanks and upstream of the separation container.

2. The modular installation according to claim 1, wherein the metal to be recovered is lithium, calcium, sodium, silicon, cobalt, manganese, cadmium, zirconium, zinc, nickel, copper, tungsten, yttrium, tin, lanthanum, silver, palladium or a combination thereof.

3. The modular installation according to claim 1, wherein the one or more movable metal treatment tanks are chemical precipitation units or an oxidation units.

4. The modular installation according to claim 3, wherein a source of base of sodium hydroxide solution is fluidically connected to an inlet of the chemical precipitation units.

5. The modular installation according to claim 3, wherein the oxidation units are provided with oxygen-containing gas bubbling devices.

6. The modular installation according to claim 1, wherein the first metal is magnesium, iron or a combination thereof.

7. The modular installation according to claim 1, comprising two movable metal treatment tanks, the second movable metal treatment tank being fluidically connected in parallel with the first movable metal treatment tank.

8. The modular installation according to claim 1, wherein the one or more movable metal treatment tanks are mounted on wheels.

9. The modular installation according to claim 1, further comprising a flotation container comprising a dissolved air flotation device configured to remove at least part of the suspended solids and residual hydrocarbons, the flotation container being fluidically connected to the one or more movable metal treatment tanks and the filtration container, the flotation container being arranged downstream of the movable metal treatment tanks and upstream of the filtration container.

10. The modular installation according to claim 9, further comprising a movable reject tank fluidically connected to an outlet of the filtration container, to an outlet of the separation container, or to an outlet of the floatation container.

11. The modular installation according to claim 10, wherein the movable reject tank is mounted on wheels.

12. The modular installation according to claim 1, wherein the filtration unit comprises a membrane configured to separate suspended solids having a volume-average median diameter Dv50 equal to or higher than 50 μm.

13. The modular installation according to claim 1, comprising the separation unit connected to the power and fluidic connectors of the separation container.

14. The modular installation according to claim 1, wherein the separation unit is a chromatographic separation unit; comprising at least one chromatography column.

15. The modular installation according to claim 1, further comprising at least one movable storage tank provided with a pH adjustment system.

16. The modular installation according to claim 15, wherein the movable storage tank is fluidically connected to the filtration container and the separation container, and is arranged downstream of the filtration container and upstream of the separation container.

17. The modular installation according to claim 16, wherein the movable storage tank comprises a recirculation loop configured to recirculate part of the aqueous stream to the movable storage tank.

18. The modular installation according to claim 17, wherein the movable storage tank is mounted on wheels.

19. A method for the treatment of an aqueous stream of produced water from an oil or gas field, the method comprising:
placing a first separation unit in the separation container and connecting the separation unit to the power and fluidic connectors in the separation container;
providing an aqueous stream comprising water, suspended solids, residual hydrocarbons, at least one metal to be recovered and a first metal different from the metal to be recovered;
passing the aqueous stream through the one or more movable metal treatment tanks so as to precipitate the first metal in the aqueous stream;
passing the aqueous stream through the filtration unit so as to remove at least part of the suspended solids from the aqueous stream;
passing the aqueous stream through the first separation unit so as to obtain an aqueous stream enriched in the metal to be recovered and an aqueous stream depleted in the metal to be recovered.

20. The method according to claim 19, wherein the metal to be recovered has a concentration equal to or higher than 3 g/L in the aqueous stream enriched in the metal to be recovered.

21. The method according to claim 19, wherein the metal to be recovered is lithium, calcium, sodium, silicon, cobalt, manganese, cadmium, zirconium, zinc, nickel, copper, tungsten, yttrium, tin, lanthanum, silver, palladium or a combination thereof.

22. The method according to claim 19, wherein the first metal is magnesium, iron or a combination thereof.

23. The method according to claim 19, wherein the aqueous stream depleted in the metal to be recovered is collected in the movable reject tank and is injected in one or more injection wells.

24. The method according to claim 23, wherein at least part of the suspended solids removed in the step of passing the aqueous stream through the filtration unit is collected in the movable reject tank.

25. The method according to claim 19, wherein the first metal precipitates in the aqueous stream by the addition of a base; of sodium hydroxide solution in the aqueous stream or by bubbling an oxygen-containing gas in the aqueous stream.

26. The method according to claim 23, wherein at least part of the suspended solids and residual hydrocarbons are removed from the aqueous stream in the dissolved air flotation device prior to the step of passing the aqueous stream through the filtration unit.

27. The method according to claim 26, wherein at least part of the suspended solids and residual hydrocarbons is collected in the movable reject tank.

28. The method according to claim 19, wherein the suspended solids removed from the aqueous stream during the step of passing the aqueous stream through the filtration unit have a volume-average median diameter Dv50 equal to or higher than 50 μm.

29. The method according to claim 19, wherein the pH of the aqueous stream is adjusted in the movable storage tank prior to being fed to the first separation unit.

30. The method according to claim 19, further comprising a step of disconnecting the first separation unit from the power and fluidic connectors of the separation container and then placing a second separation unit different from the first separation unit in the separation container and connecting the second separation unit to the power and fluidic connectors in the separation container, and repeating the steps of:
providing an aqueous stream comprising water, suspended solids, residual hydrocarbons, at least one metal to be recovered and a first metal different from the metal to be recovered;
passing the aqueous stream through the one or more movable metal treatment tanks so as to precipitate the first metal in the aqueous stream;
passing the aqueous stream through the filtration unit so as to remove at least part of the suspended solids from the aqueous stream;
passing the aqueous stream through the second separation unit so as to obtain an aqueous stream enriched in the metal to be recovered and an aqueous stream depleted in the metal to be recovered.
